(19) United States
(12) Patent Application Publication
(10) Pub. No.: US 2009/0109502 A1
(43) Pub. Date: Apr. 30, 2009

(54) IMAGE PROCESSING APPARATUS, IMAGE SCANNING APPARATUS, AND IMAGE PROCESSING METHOD

(75) Inventor: Katsushi MINAMINO, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Minami-ku (JP)

(21) Appl. No.: 12/190,625

(22) Filed: Aug. 13, 2008

(30) Foreign Application Priority Data
Oct. 26, 2007 (JP) 2007-278877

(51) Int. Cl. H04N 1/047

(52) U.S. Cl. 358/488

(57) ABSTRACT

In an image processing apparatus, an inclination detecting unit acquires, with respect to each line of image data, positions of a left edge pixel and a right edge pixel that are positioned at a boundary between an original document and a background. A feature point position is acquired based on features of the positions of the edge pixels of a plurality of lines. Based on a feature of the position of at least one of the left edge pixel and the right edge pixel of the line that includes the feature point position or of the line that is near the former line, a status regarding a direction of the document is acquired. Furthermore, the acquired statuses are counted, the most counted status is determined, two feature points are selected from the feature points having a status that matches the most counted status, and the document inclination is calculated from the two feature point positions. Thereafter, the inclination of the document can be compensated for.

### CROSS-REFERENCE TO RELATED APPLICATION

This application claims priority under 35 U.S.C. 119 to Japanese Patent Application No. 2007-278877, filed on Oct. 26, 2007, which application is hereby incorporated by reference in its entirety.

### BACKGROUND OF THE INVENTION

1. Field of the Invention

The present invention primarily relates to an image processing apparatus that automatically detects inclination of image data acquired by scanning an original document.

2. Description of the Related Art

In an image scanner apparatus, for example, a copier, a facsimile machine, an Optical Character Reader (OCR), or other suitable image scanner apparatus, when an original document is scanned in an inclined state, an inclined image is acquired, thereby deteriorating an image quality. In order to prevent such deterioration, an image scanning apparatus has been suggested which includes an image processing apparatus arranged to automatically detect an inclination angle of the original document by analyzing image data, and to electronically adjust the inclination by performing a process of rotating the image data based on the acquired inclination angle.

For example, an inclination extracting apparatus that can increase the speed of an inclination extracting process by including a pixel position detecting unit, a local minimum point extracting unit, and an inclination extracting unit is well known. In such an apparatus, the pixel position detecting unit scans acquired image data in one direction and detects, with respect to each scan line, a position of a character pattern starting edge pixel that is detected in a prescribed order sequentially counted on the scan line. The local minimum point extracting unit extracts a position of a pixel that is a minimum of the starting edge pixels detected with respect to each scan line. The inclination extracting unit extracts the inclination of an information medium based on the position of the extracted minimum pixel.

In order to easily and effectively detect the inclination of a scanned image, after the scanned image is stored in an image memory by a scanning unit, such as an image scanner, another well-known apparatus extracts consecutive black pixel components by scanning the scanned image and detects inclination of the scanned image by using the height and width, for example, of a circumscribed rectangle of the consecutive black pixel components.

However, in the above-described configuration of the inclination extracting apparatus, when the pixel that forms a character pattern cannot be detected, the inclination cannot be detected. Similarly, in the above-described configuration of the other well-known apparatus, when the consecutive black pixel components cannot be detected, the inclination cannot be detected.

In each configuration described above, when an original document having an inclined text due to its design, for example, or an original document having a slant line is scanned, even if such original documents are properly positioned, the inclination is incorrectly detected at the time of scanning, and the image data may be unintentionally rotated. Therefore, an image processing apparatus that can properly correct the inclination regardless of the content of an original document is desirable. Moreover, when the original document is not in good condition, such as when a corner portion of the original document is dog-eared, torn, curled up, twisted, or wrinkled, for example, it is difficult to position these types of documents accurately on the apparatus to scan them. Therefore, an image processing apparatus has been desired that can properly correct the inclination even in the above-described cases.

### SUMMARY OF THE INVENTION

To overcome the problems described above, preferred embodiments of the present invention provide an image processing apparatus, an image scanning apparatus, and an image processing method.

According to a first preferred embodiment of the present invention, an image processing apparatus includes an edge pixel acquiring unit, a feature point detecting unit, a status acquiring unit, and an inclination calculating unit. The edge pixel acquiring unit acquires, with respect to each line of image data acquired by scanning an original document, positions of a first edge pixel and a second edge pixel that are positioned at a boundary between the original document and a background. The feature point detecting unit detects a feature point of an outline of the original document based on the feature of the position of at least one of the first edge pixel and the second edge pixel of a plurality of lines. Based on the feature of the position of at least one of the first edge pixel and the second edge pixel of the line including a position of the feature point or of the line that is in the vicinity of the line including a position of the feature point, the status acquiring unit acquires, with respect to each feature point, a status indicating that the original document is not inclined, a status indicating that the document is inclined towards one side, or a status indicating that the document is inclined towards the other side. The inclination calculating unit counts the statuses of a plurality of feature points, acquires the most counted status, selects two feature points from the feature points having the status that matches the most counted status, and calculates a value regarding the inclination of the original document from the positions of the two selected feature points.

The status of “no inclination” includes a status that means that no rotation is required. The status of “inclination towards one (or the other) side” includes a status that means that the document should be rotated in a direction that corrects the inclination.

In the above-described configuration, since the inclination is detected based on an outline feature of the original document, and not on the content of the original document, the inclination of the original document can be directly and accurately detected. Furthermore, since the inclination is detected based on a comprehensive determination using the feature points of an outline and statuses thereof of the original document, the inclination of the original document can be accurately detected, and the inclination of original documents having various shapes including a non-rectangular original document (such as an original document having a non-straight side) can be properly detected.

The inclination calculating unit preferably selects, in accordance with a predetermined priority order, two feature points from the feature points having the status that matches the most counted status.

By properly predetermining the priority order, the accuracy of inclination detection can be further improved. In particular, even when a corner portion or other portion of the original document is, for example, dog-eared, torn, curled up, twisted, or wrinkled or otherwise damaged, the inclination can be properly detected. Moreover, since the process of selecting the feature points can be simplified, a processing time for the inclination detection can be reduced.

The feature point detecting unit can preferably detect the corner portion of the original document as the feature point.

By using the corner portion of the original document as the feature point, two sufficiently separated feature points can be selected for the inclination calculation, and a value representing the inclination of the original document can be accurately detected.

The image processing apparatus according to preferred embodiments of the present invention preferably performs the following functions. (1) When the corner portion of the original document is detected as the feature point, the feature point detecting unit determines whether or not an angle of the corner portion is approximately a right angle based on the position of at least one of the first edge pixel and the second edge pixel. (2) When the angle of the corner portion is not a right angle, the inclination calculating unit excludes the feature point thereof, counts the statuses, and then, after excluding the corner portion from the feature points having the status that matches the most counted status, the inclination calculating unit selects the two feature points.

Since the calculation of the value regarding the inclination based on the non-right-angle corner portion can be prevented, erroneous detection of the inclination can be prevented.

Preferably, the feature point detecting unit can acquire, as the feature points, at least two points that are positioned on one of parallel sides that face each other on each side in a longitudinal direction of a line, the two points being positioned on a portion other than the corner portion of the original document.

Even when an original document having an irregular shape (such as an original document having a round-cornered rectangular shape, a non-rectangular shape, or a non-square shape, for example) is scanned, as long as the document includes a parallel side, the inclination of the original document can be properly detected based on the two feature points that are positioned on the parallel side. For example, an original written document is often dog-eared, torn, curled up or otherwise damaged at its corner portion after a lapse of a period of time from its creation. However, even in such cases, the inclination can be properly detected based on a parallel side. Moreover, even when a sheet of an original document is crumpled up and then smoothed out, and thus has an irregular shape, if a portion of a parallel side is detected at one portion of the original document, the inclination can be detected with constant accuracy based on the detected parallel side.

In the image processing apparatus, when the most counted status cannot be acquired, the inclination calculating unit preferably calculates the value regarding the inclination of the original document from the positions of the two feature points positioned on one of the parallel sides of the original document.

Thus, even when it is difficult to detect an accurate position of a corner portion of an original document having, for example, a round corner, as long as the document has a parallel side, the inclination of the original document can be properly detected based on the parallel side. Accordingly, the inclination detection can be performed with high versatility.

According to a second preferred embodiment of the present invention, an image scanning apparatus including the image processing apparatus includes an image scanning unit arranged to acquire image data by scanning an original document, and a rotation processing unit arranged to perform a rotation process on the image data so as to correct inclination thereof.

With respect to the image data scanned by the image scanning unit, the inclination of the original document can be accurately detected and corrected based on a comprehensive determination using a plurality of feature points and statuses thereof. Moreover, the inclination of an original document having a wide width can be properly corrected.

In the image scanning apparatus according to this preferred embodiment of the present invention, the edge pixel acquiring unit of the image processing apparatus preferably acquires the positions of the first edge pixel and the second edge pixel in each line arranged along a main scanning direction of the image scanning unit.

The position of the edge pixel can be preferably acquired while data of the pixels consecutively input in the main scanning direction at the time of scanning are sequentially processed. Accordingly, since storing of the data in a memory and the scanning process can be omitted, the processes can be simplified, and the time required for the inclination of the scanned image to be detected can be reduced.

In the image scanning apparatus according to this preferred embodiment of the present invention, the image scanning unit preferably includes a flat bed unit.

In the above-described configuration, even when the original document is not positioned in a proper or straightened state on the flat bed unit, an image that is corrected in a normal direction by the inclination calculating unit and the rotation processing unit can be acquired. Accordingly, the original document may be positioned on the flat bed unit in any direction and scanned, thereby facilitating operational performance.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a front sectional view illustrating an entire configuration of an image scanner apparatus according to a preferred embodiment of the present invention.

FIG. 2 is a block diagram illustrating an electrical configuration of the image scanner apparatus shown in FIG. 1.

FIG. 3 is a flowchart representing a main routine of an inclination detecting process executed by an inclination detecting unit according to a preferred embodiment of the present invention.

FIG. 4 illustrates original document pixels detected from image data according to a preferred embodiment of the present invention.

FIG. 5 is a flowchart of a sub routine according to a preferred embodiment of the present invention in which a leading corner portion of an original document is detected.

FIG. 6 illustrates a process of detecting the leading corner portion of the original document according to a preferred embodiment of the present invention.

FIG. 7 is a flowchart of a sub routine according to a preferred embodiment of the present invention in which a left-hand corner portion of the original document is detected.

FIG. 8 illustrates a process of detecting the left-hand corner portion of the original document according to a preferred embodiment of the present invention.

FIG. 9 is a flowchart of a sub routine according to a preferred embodiment of the present invention in which a parallel side of the original document is detected.

FIG. 10 illustrates a process of detecting the parallel side of the original document according to a preferred embodiment of the present invention.

FIG. 11 is a flowchart of a sub routine according to a preferred embodiment of the present invention in which a trailing corner portion of the original document is detected.

FIG. 12 illustrates an example of feature points of an outline detected with respect to a rectangular original document and an example of the statuses of the feature points according to a preferred embodiment of the present invention.

FIG. 13 illustrates an example of a priority order by which two feature points used to calculate inclination are selected according to a preferred embodiment of the present invention.

FIG. 14 illustrates an inclination detecting process according to a preferred embodiment of the present invention performed when the left-hand corner portion of the original document is dog-eared and torn.

FIG. 15 illustrates an inclination detecting process according to a preferred embodiment of the present invention performed when the leading corner portion of the original document is substantially dog-eared.

FIG. 16 illustrates an inclination detecting process according to a preferred embodiment of the present invention performed when the original document has a non-square shape.

### DETAILED DESCRIPTION OF PREFERRED EMBODIMENTS

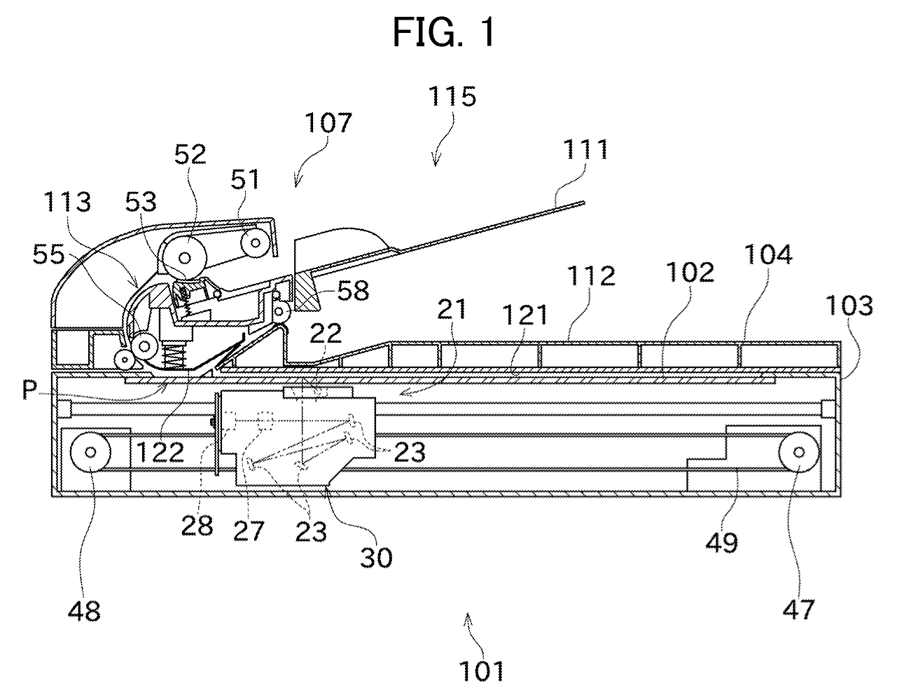

Preferred embodiments of the present invention will be described with respect to FIGS. 1-16. FIG. 1 is a front sectional view illustrating an entire configuration of an image scanner apparatus according to a preferred embodiment of the present invention.

As illustrated in FIG. 1, an image scanner apparatus 101 defining an image scanning apparatus includes an image scanning unit 115 having an Auto Document Feeder (ADF) unit and a flat bed unit.

A detailed description thereof will be provided below. The image scanner apparatus 101 includes an original document table 103 having a platen glass 102 on which an original document is placed, and an original document table cover 104 arranged to maintain the original document in an orientation such that the document is pressed against the platen glass. The image scanner apparatus 101 also includes an operation panel (not illustrated) to commence the start of original document scanning, or other suitable operations. A pressing pad 121 that presses the original document downward is preferably attached to a lower surface of the original document table cover 104 such that the pad 121 faces the platen glass 102.

The original document table cover 104 preferably includes an ADF device 107. The ADF device 107 preferably includes an original document tray 111 arranged on an upper portion of the original document table cover 104 and a discharge tray 112 arranged below the original document tray 111.

As illustrated in FIG. 1, a curved original document transportation path 113 that links the original document tray 111 to the discharge tray 112 is preferably arranged inside the original document table cover 104. The original document transportation path 113 preferably includes a pick up roller 51, a separation roller 52, a separation pad 53, a transportation roller 55, and a discharge roller 58.

The pick up roller 51 picks up the original document placed on the original document tray 111, and the separation roller 52 and the separation pad 53 separate the picked up original document one sheet at a time. The transportation roller 55 transports the separated original document to an original document scanning position P, and the discharge roller 58 discharges the scanned original document onto the discharge tray 112. A pressing member 122 facing the platen glass is preferably arranged at the original document scanning position P.

In the above-described configuration, the original documents stacked and placed on the original document tray 111 are separated one sheet at a time and transported along the curved original document transportation path 113. Then, after the original document passes through the original document scanning position P and is scanned by a scanner unit 21, which will be described below, the document is discharged on the discharge tray 112.

As illustrated in FIG. 1, the scanner unit 21 is arranged inside the original document table 103. The scanner unit 21 preferably includes a carriage 30 that is movable inside the original document table 103.

The carriage 30 preferably includes a fluorescent lamp 22 as a light source, reflection mirrors 23, a condenser lens 27, and a Charge Coupled Device (CCD) 28. The fluorescent lamp 22 irradiates light to the original document. After the light reflected from the original document is reflected by the plurality of reflection mirrors 23, the light passes through the condenser lens 27, converges, and forms an image on a front surface of the CCD 28. The CCD 28 converts the irradiated and converged light into an electrical signal and outputs the signal.

In the present preferred embodiment of the present invention, the CCD 28 is preferably a 3-line color CCD. The CCD 28 includes a one-dimensional line sensor with respect to each color of Red, Green, and Blue (RGB). Each of the line sensors substantially extends in a main scanning direction (i.e., a width direction of an original document). The CCD 28 also preferably includes different color filters that correspond to each line sensor.

A driving pulley 47 and a driven pulley 48 are preferably rotationally supported inside the original document table 103. An endless drive belt 49 is preferably arranged between the driving pulley 47 and the driven pulley 48 in a tensioned state. The carriage 30 is fixed to a proper position of the drive belt 49. In the above-described configuration, by forwardly and reversely driving the driving pulley 47 using an electric motor (not illustrated), for example, the carriage 30 can travel horizontally along a sub scanning direction.

In the above-described configuration, when the carriage 30 is disposed ahead of a position that corresponds to the original document scanning position P, the ADF 107 is driven. Accordingly, the original document to be transported in the original document transportation path 113 is scanned at the original document scanning position P. The reflection light, which is irradiated from the fluorescence lamp 22 and reflected by the original document, is introduced into the carriage 30, directed to the CCD 28 by the reflection mirrors 23, via the condenser lens 27, and forms an image. Thus, the CCD 28 can output an electrical signal that corresponds to the scanned content.

When using a flat bed scanner, while the carriage 30 is moved at a prescribed speed along the platen glass 102, an original document placed on the platen glass 102 is scanned. The reflection light from the original document is similarly introduced into the CCD 28 of the carriage 30 and forms an image.

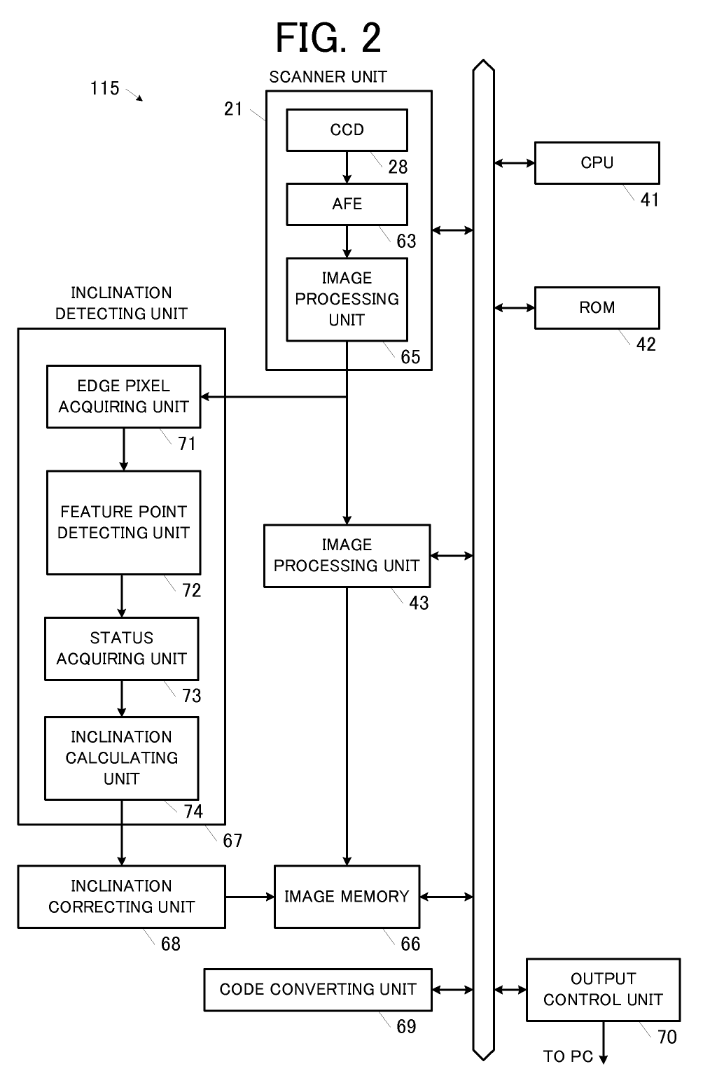

FIG. 2 is a block diagram of the image scanner apparatus 101. As illustrated in FIG. 2, in addition to the scanner unit 21, the image scanner apparatus 101 preferably includes a Central Processing Unit (CPU) 41, a Read Only Memory (ROM) 42, an image processing unit 43, an image memory 66, an inclination detecting unit 67, an inclination correcting unit 68, a code converting unit 69, and an output control unit 70.

The CPU 41 functions as a control unit that controls, for example, the scanner unit 21, the inclination detecting unit 67, the inclination correcting unit 68, and the output control unit 70 which are included in the image scanner apparatus 101. Programs and data, or other suitable control elements, are stored in the ROM 42 which defines a storage unit.

The scanner unit 21 preferably includes an Analog Front End (AFE) 63. The AFE 63 is connected with the CCD 28. At the time of scanning the original document, the line sensor of each color of RGB included in the CCD 28 scans one line of the original document content by scanning in the main scanning direction, and the signal of each line sensor is converted from an analog signal into a digital signal by the AFE 63. By this main scanning, pixel data of one line is output as a tone value of each color of RGB from the AFE 63. By repeating the above-described process while the original document is being transported through the original document scanning position, or the carriage 30 is moved in the sub scanning direction of the flat bed, image data of the entire original document can be acquired as digital signals.

The scanner unit 21 includes an image processing unit 65, and the digital signals of the image data output from the AFE 63 are input into the image processing unit 65. The image processing unit 65 preferably performs shading correction on the pixel data input line by line with respect to each main scanning operation, and corrects scanned unevenness that arises from an optical system of the scanner unit 21. The image processing unit 65 preferably performs, on the pixel data, correction that corrects color shift caused by line gaps of the line sensor of each color of RGB in the CCD 28.

The image memory 66 stores images scanned by the scanner unit 21. After a well-known image processing method (such as filter processing) is performed in the image processing unit 43, the image data scanned by the scanner unit 21 is input into the image memory 66 where it is stored.

The image scanner apparatus 101 includes an inclination detecting unit (image processing apparatus) 67 arranged to detect the inclination of the original document scanned by the CCD 28. When the image data is input line by line from the image processing unit 65 of the scanner unit 21, the inclination detecting unit 67 preferably performs a process of analyzing the image data and detects the inclination (i.e., an angle to be rotated to correct the inclination) of the original document.

The inclination detecting unit 67 includes, for example, an edge pixel acquiring unit 71, a feature point detecting unit 72, a status acquiring unit 73, and an inclination calculating unit 74.

Each time the image data is input line by line from the scanner unit 21, the edge pixel acquiring unit 71 preferably acquires, with respect to each line, a position of an edge pixel positioned at an outline portion (in other words, a boundary between the original document and a background) of the original document.

The feature point detecting unit 72 can store the positions of the edge pixels of a prescribed number of lines, the edge pixels being acquired by the edge pixel acquiring unit 71. Based on features of the positions of the edge pixels of the plurality of lines, feature points related to an outline of the original document are detected, and positions of the feature points can be acquired. In the present preferred embodiment, the “feature point” refers to a point that is positioned at a graphic characteristic portion of the outline of the original document, such as the top of a corner portion of the original document.

The status acquiring unit 73 checks the positions of the edge pixels of the line including the feature points acquired by the feature point detecting unit 72 or of the line that is in the vicinity of the previous line. Based on the checked result, the status acquiring unit 73 preferably acquires a status of the original document that indicates whether the original document is not inclined, is inclined towards one side, or is inclined towards the other side.

Preferably, the inclination calculating unit 74 counts the status of each feature point and acquires the most commonly counted status, selects two feature points from the feature points that have a status that matches the most commonly counted status, calculates and acquires a value (i.e., a parameter that expresses the inclination, and, in the present preferred embodiment of the present invention, refers to a tangent value) regarding the inclination of the original document from the positions of the selected feature points.

An inclination detecting process performed by the above-described edge pixel acquiring unit 71, feature point detecting unit 72, status acquiring unit 73, and inclination calculating unit 74 will be described in detail below.

Based on the inclination (tangent value) acquired by the inclination detecting unit 67, the inclination correcting unit 68 performs a rotation process at the time of reading the image data stored in the image memory 66, and electronically corrects the inclination of the original document.

The code converting unit 69 encodes the image data stored in the image memory 66 by performing a well-known compression process, such as, a Joint Photographic Experts Group (JPEG), for example.

The output control unit 70 transmits the encoded image data to, for example, a personal computer (not illustrated) defining a higher-level device connected with the image scanner apparatus 101. A transmission method may be selected and includes, for example, a method that uses a Local Area Network (LAN) and a method that uses a Universal Serial Bus (USB).

In the present preferred embodiment of the present invention, the image processing unit 65, the inclination detecting unit 67, the inclination correcting unit 68, the code converting unit 69, or other suitable units, are implemented by using hardware such as, Application Specific Integrated Circuits (ASIC) or a Field Programmable Gate Array (FPGA), for example. The image processing unit 65 and the inclination detecting unit 67, or other suitable units, may be implemented by a combination of the CPU 41 and various programs, for example.

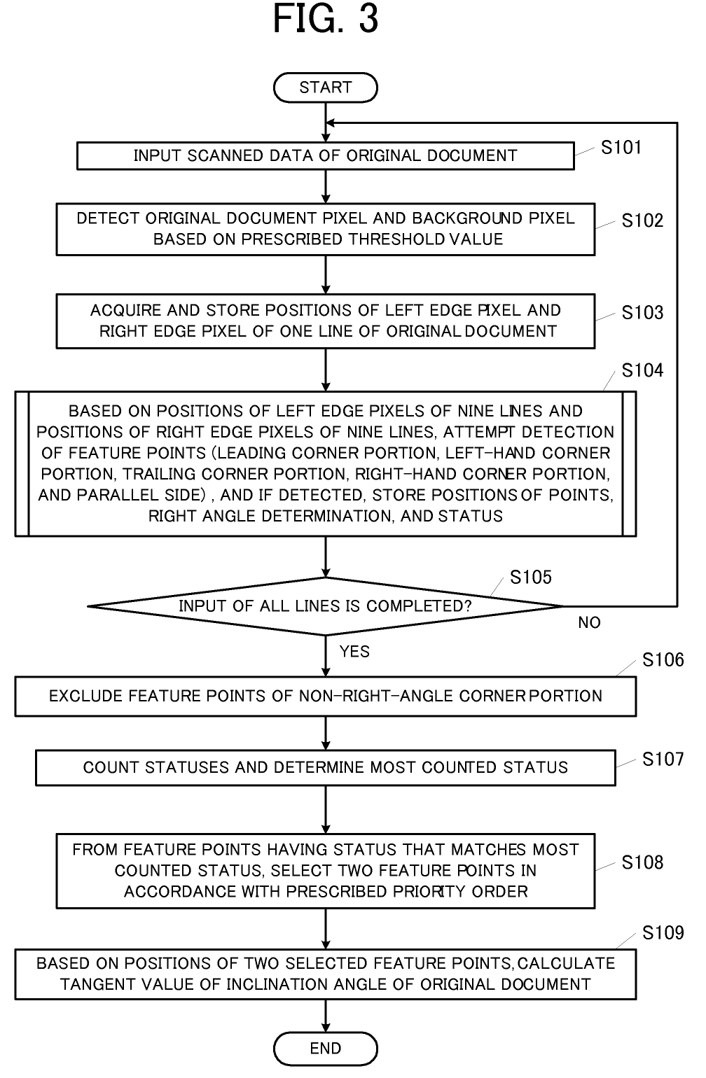

Next, a process of detecting the inclination of the original document performed by the inclination detecting unit 67 according to a preferred embodiment of the present invention will be described with reference to the flowchart of FIG. 3. FIG. 3 represents a main routine of the inclination detecting process.

When the main routine of FIG. 3 is started, the inclination detecting unit 67 inputs the pixel data of one line output by the image processing unit 65 (S101). Then, a process of detecting an original document pixel and a background pixel is performed based on the input pixel data of one line (S102).

In the present preferred embodiment of the present invention, the detecting process of the original document pixel and the background pixel is preferably performed as follows. A white sheet (i.e., a platen sheet) that is preferably brighter than a normal sheet of paper is attached to a front surface of the pressing pad 121 and the pressing member 122 (FIG. 1), and arranged on the opposite side from the original document to be scanned. Accordingly, in the image data scanned by the CCD 28, a background portion of a surrounding area of the original document preferably has higher luminance.

Thus, in the process of S102, image processing that calculates luminance (Y component) from RGB components of the pixel data is performed in accordance with a well-known expression. When the calculated luminance is greater than or equal to a prescribed threshold value, a binarization process that determines that a pixel is a background pixel is performed, and when the calculated luminance is below the threshold value, a binarization process that determines a pixel as the original document pixel is performed. In the present preferred embodiment of the present invention, “0” refers to the background pixel, and “1” refers to the original document pixel.

In view of detection accuracy of the original document pixel and the background pixel, proper image processing, such as shading correction and gamma correction may preferably be performed on the original image data before the process of S102 is performed. In the shading correction, the original document can be easily distinguished from the background by a process of adding a prescribed value of white shading data to generate a value that is brighter than a normal value. Alternatively, a black pressing pad 121 and a pressing member 122 could be used, and the original document can be distinguished from the background by determining black pixels scanned at an edge portion side of the main scanning direction as being the background pixels. When the image scanner apparatus 101 is used as a flat bed scanner, and an original document from, for example, a book is scanned in a state in which the original document table cover 104 is open, the black pixels scanned around the edge portion of the main scanning direction may similarly be determined as the background pixels.

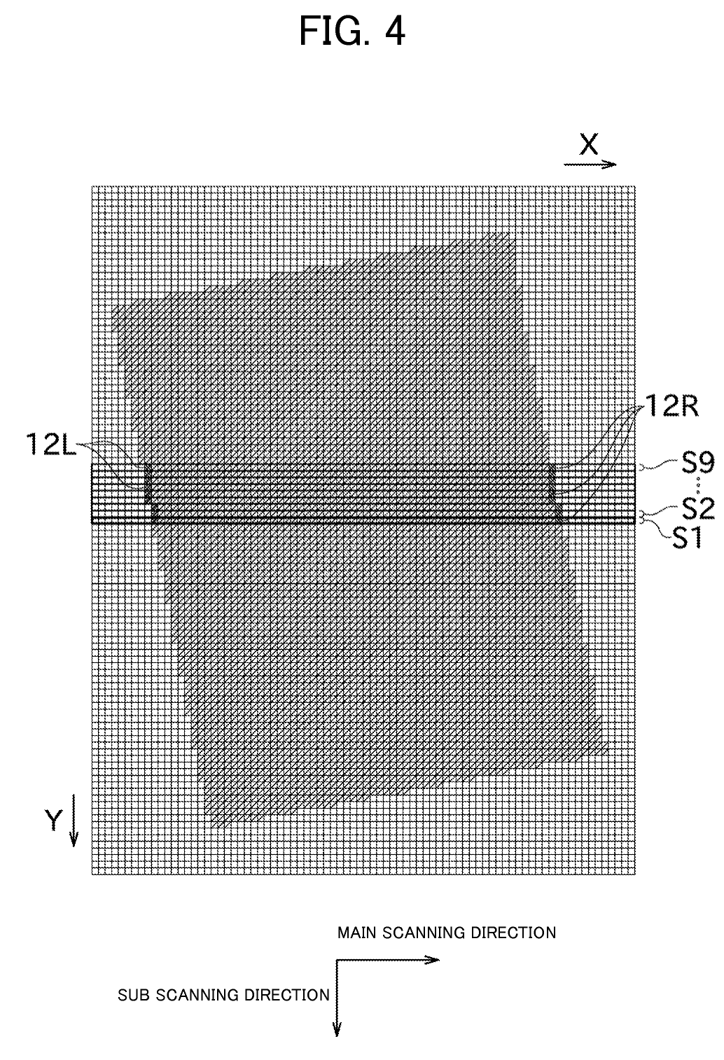

Accordingly, as illustrated in FIG. 4, an original document area can be determined from the image data. In FIG. 4, each box of the finely separated grid indicates one pixel, each blank box indicates a background pixel, and each shaded box indicates an original document pixel. In FIG. 4, a direction “X” indicates the main scanning direction, and a direction “Y” indicates the sub scanning direction.

In FIG. 4, the entire image data is illustrated so as to easily recognize an entire area of the original document pixels, however, the detection process of the original document pixels and the background pixels of S102 in FIG. 3 is sequentially performed pixel by pixel along a line in the same direction as the main scanning direction. In the following description, a situation will be described in which a rectangular original document is transported in an oblique state by the ADF unit, scanned by the scanner unit 21, and as result, a rectangular image that is slightly rotated in a counterclockwise direction from a proper position is acquired as an original document pixel area. When the rectangular original document is obliquely placed on the platen glass 102 of the flat bed scanner unit, the image inclined as illustrated in FIG. 4 is also acquired as the original document pixel area. At the inclination detecting unit 67, the image data is processed line by line from an upper edge thereof, as shown FIG. 4, and a line of a lower edge is processed last.

As described above, in the process of S102 of FIG. 3, the pixels are processed one pixel at a time from one edge to the other edge (from the left edge to the right edge) of each line. Each time the process of S102 is performed on one pixel, a change in the data after the binarization is checked (S103). In the process of S103, when the pixels are sequentially processed from the left edge with respect to each line, the pixel of “1” at a position at which the pixel is changed from “0” to “1” first after the binarization (in other words, from the background to the original document) is recognized as a first edge pixel (a left edge pixel). The pixel that was “1” at a position at which the pixel is changed from “1” to “0” last after the binarization (in other words, from the original document to the background) is recognized as a second edge pixel (a right edge pixel).

The two edge pixels (the left edge pixel and the right edge pixel) acquired as described above indicate the boundary between the original document and the background (i.e., the outline of the original document) on the respective line. In the process of S103, the positions of the left edge pixel and the right edge pixel are properly stored in the memory defining a proper storage unit.

The inclination detecting unit 67 of the present preferred embodiment of the present invention can store the positions of the two acquired edge pixels of the currently processed line, and the positions of each of the two acquired edge pixels of the immediately previously processed eight lines, that is, the positions of each of the two acquired edge pixels of the nine lines in total. In FIG. 4, reference symbol S1 refers to the line that is processed at a particular moment, and S2 through S9 refer to the immediately previously processed eight lines. Moreover, fine hatching is performed on the grids that correspond to the positions of left edge pixels 12L and of right edge pixels 12R.

After the detection process of the edge pixels, based on features of the positions of the left pixels 12L and the right edge pixels 12R of the nine lines, feature points (for example, the top of a corner portion of the original document) regarding the outline of the original document are detected (S104).

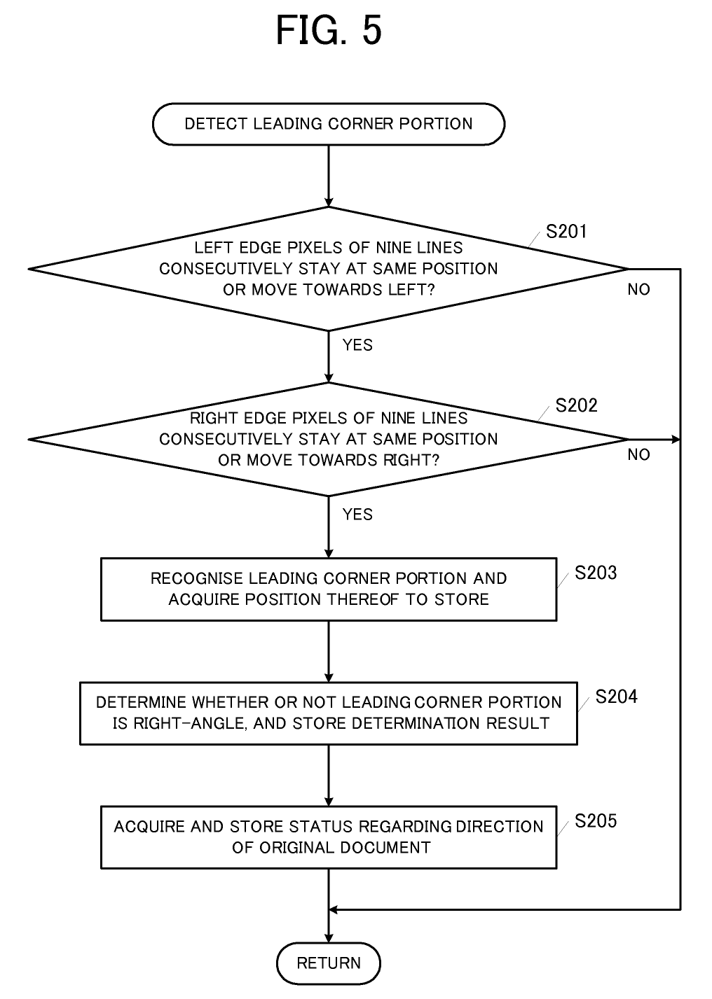

Now, with reference to FIG. 5, a process of detecting a corner portion (i.e., a leading corner portion) positioned on a leading side of the original document will be described as the first example of a specific process in which the feature points are detected. The flow of FIG. 5 represents one sub routine executed in the process of S104 of FIG. 3.

In the sub routine of FIG. 5, in the nine lines from the line that was processed earliest to the line that is currently processed, as the past line comes closer line by line to the new line, each of the left edge pixels are consecutively checked to determine whether they stay at the same position or move towards the left (S201). If the above-described conditions are not met, it is determined that the leading corner portion has not been detected, and the sub routine is ended.

If the conditions are met, as the earliest processed line comes closer line by line to the currently processed line, it is checked whether each of the right edge pixels are consecutively checked to determine whether they stay at the same position or move towards the right (S202). If the conditions of S202 are met, the leading corner portion is recognized (S203). If the conditions are not met, it is determined that the leading corner portion has not been detected, and the sub routine is ended.

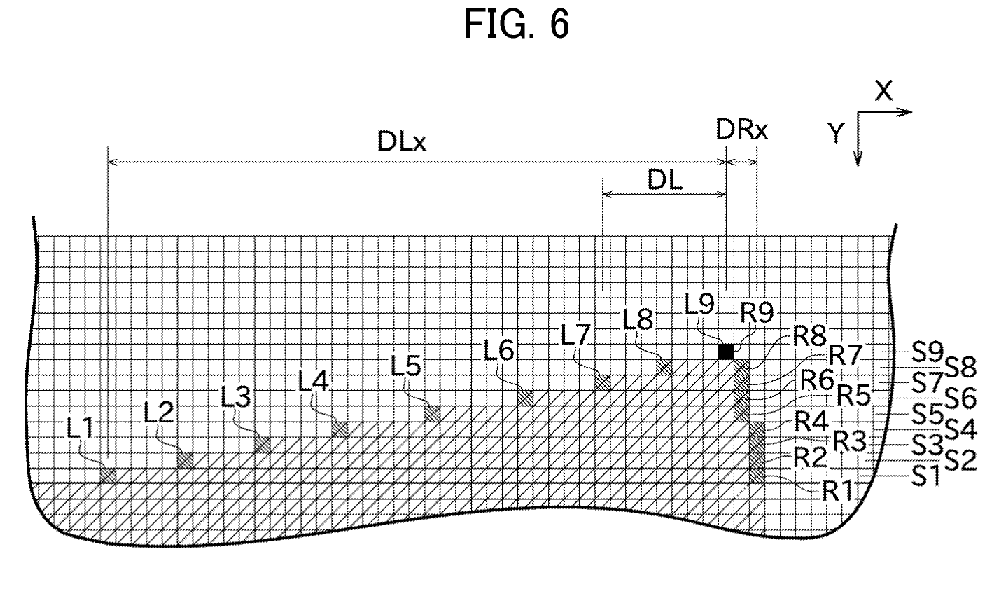

The determinations made in S201 and S202 will be described in detail with reference to FIG. 6. The line S1 that is currently processed is illustrated in FIG. 6, and it is assumed that, as a result of the process of S103 of FIG. 3, the positions of the left edge pixel L1 and the right edge pixel R1 have been acquired as illustrated in FIG. 6. It is also assumed that, in the processes performed on the previously processed eight lines, the positions of the left edge pixels L2 through L9 and the right edge pixels R2 through R9 are acquired and stored.

In this case, in the process of S201 of FIG. 5, in an area of the nine lines, as the previous line comes closer line by line to the new line, it is determined whether each of the left edge pixels stays at the same position or moves towards the left.

For example, in FIG. 6, as the earliest processed line S9 shifts to a newer line S8, the position of the left edge pixel moves from L9 to L8 in a direction that comes closer to a left edge. As is the same in the cases in which the line S8 shifts to the line S7, the line S2 shifts to the currently processed line S1 (L8 through L1). Accordingly, in the case of FIG. 6, it is determined that the conditions of S201 of FIG. 5 are met.

In the process of S202, in the area of the nine lines, as the past line comes closer line by line to the new line, it is determined whether each of the right edge pixels stays at the same position or moves towards the right.

In the example of FIG. 6, as the earliest processed line S9 shifts to the new line S8, the position of the right edge pixel moves from R9 to R8 in a direction that comes closer to a right edge. When the line S8 shifts to the line S7, it is obvious from R8 and R7 that the right edge pixel stays at the same position. When the line S7 shifts to the line S6, and when the line S6 shifts to the line S5, each of the right edge pixels stays at the same position (R7 through R5). When the line S5 shifts to the currently processed line S4, the right edge pixel from R5 to R4 moves in a direction that comes close to the right edge. When the line S4 shifts to the line S3, and when the line S3 shifts to the line S2, each of the right edge pixels stays at the same position. When the line S2 shifts to the currently processed line S1, the right edge pixel moves from R2 to R1 in the direction that comes closer to the right edge. Accordingly, in the case of FIG. 6, it is determined that the conditions of S202 of FIG. 5 are met.

Accordingly, in the example of FIG. 6, the sub routine proceeds to the process of S203, and the leading corner portion of the original document is recognized. More specifically, the position of the original document pixel on the line S9 that is processed earliest is recognized as the position of the leading corner portion. In FIG. 6, since there is only one original document pixel on the line S9, the pixel is recognized as the leading corner portion (refer to the blackened grid). The detected position of the leading corner portion of the original document is properly stored in the memory.

When the leading corner portion of the original document is detected as described above, it is then determined in the process of S204 of FIG. 5 whether or not the corner portion has approximately a right angle.

The determination of the right angle is made based on the features of the positions of the left edge pixels and the right edge pixels of the nine lines. More specifically, a distance DLx by which the left edge pixel moves from the earliest processed line S9 to the current line S1 towards a left edge side and a distance DRx by which the right edge pixel moves from the earliest processed line S9 to the current line S1 towards a right edge side are calculated.

When the “DLx>DRx”, it is checked whether or not a distance DL by which the left edge pixel moves towards the left edge side while the earliest processed line S9 shifts to the next line by DRx lines substantially equals about 8. When the distance DL substantially equals about 8, it is determined that the corner portion has a right angle. When the distance DL does not substantially equal about 8, it is determined that the corner portion does not have a right angle.

When the “DLx<DRx”, it is checked whether or not a distance DR by which the right edge pixel moves towards the right edge side while the earliest processed line S9 shifts to the new line by DLx lines substantially equals about 8. When the distance DR substantially equals about 8, it is determined that the corner portion has a right angle. When the distance DR does not substantially equal about 8, it is determined that the corner portion does not have a right angle.

In the example of FIG. 6, while the earliest processed line S9 shifts to the current line S1, the left edge pixel moves 42 pixels towards the left edge side, and the right edge pixel moves 2 pixels towards the right edge side (refer to the positions of L9, L1, R9, and R1). Accordingly, since the “DLx=42” and the “DRx=2”, the “DLx>DRx”. While the earliest processed line S9 shifts to the new line S7 by two lines, the left edge pixel moves from the line S9 to the line L7 by 8 pixels towards the left edge side, and “DL=8”. Accordingly, in the example of FIG. 6, it is determined in the process of S204 of FIG. 5 that the leading corner portion is substantially perpendicular.

In the process of S205, the status regarding the direction of the original document is acquired. The status indicates whether the original document is not inclined, the document is rotated in a clockwise direction, or the document is rotated in a counterclockwise direction. In addition to the process described above, the status preferably indicates whether the original document is not required to be rotated, the document is required to be rotated in the counterclockwise direction, or the document is required to be rotated in the clockwise direction.

More specifically, when the distances DLx and DRx satisfy the relationship of “DLx>DRx”, the rotation in the counterclockwise direction is determined, and when the distances DLx and DRx satisfy the relationship of “DLx<DRx”, the rotation in the clockwise direction is determined. When the “DLx=0” and the “DRx=0”, it is determined that the document is not inclined.

In the example of FIG. 6, since the “DLx>DRx”, it is determined in S205 of FIG. 5 that the image is rotated in the counterclockwise direction. Accordingly, in the process of S205, the status of “counterclockwise rotation” is stored in a proper memory in association with the position of the leading corner portion acquired in the process of S203.

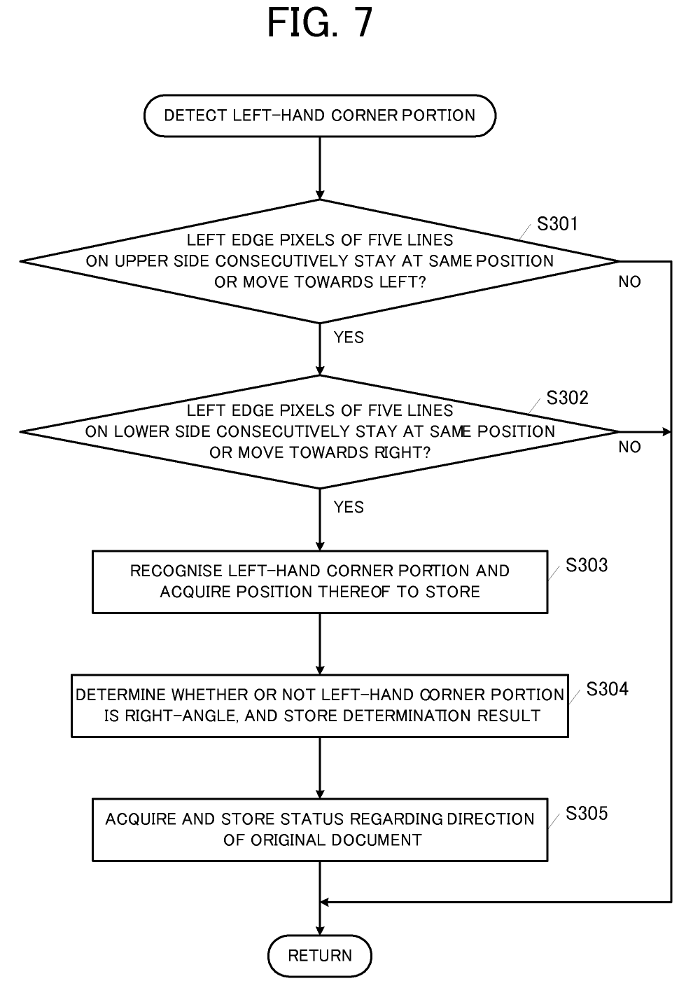

Next, with reference to FIG. 7, a process of detecting a corner portion (left-hand corner portion) that is positioned on a left side of the original document will be described as the second example of a specific example in which feature points are detected. Similar to the flow of FIG. 5, the flow of FIG. 7 represents one sub routine executed in S104 of FIG. 3.

When the sub routine of FIG. 7 is executed, firstly, in the nine lines, positions of the left edge pixels of the five lines from the line S9 that was processed in the earliest processed time to the line S5 that is the center line are checked (S301). More specifically, in the lines of S9 through S5, as the earliest processed line comes close line by line to the new line, it is checked whether each of the left edge pixels stays at the same position or moves towards the left. When these conditions are not met, it is determined that the left-hand corner portion has not been detected, and the sub routine is ended.

When the conditions of S301 are met, the positions of the right edge pixels of the five lines from the center line S5 to the currently processed line S1 are checked (S302). More specifically, in the lines of S5 through S1, as the previous line comes closer line by line to the new line, it is checked whether each of the left edge pixels stays at the same position or moves towards the right. When these conditions are met, the left-hand corner portion is recognized (S303). When the conditions are not met, it is determined that the left-hand corner portion has not been detected, and the sub routine is ended.

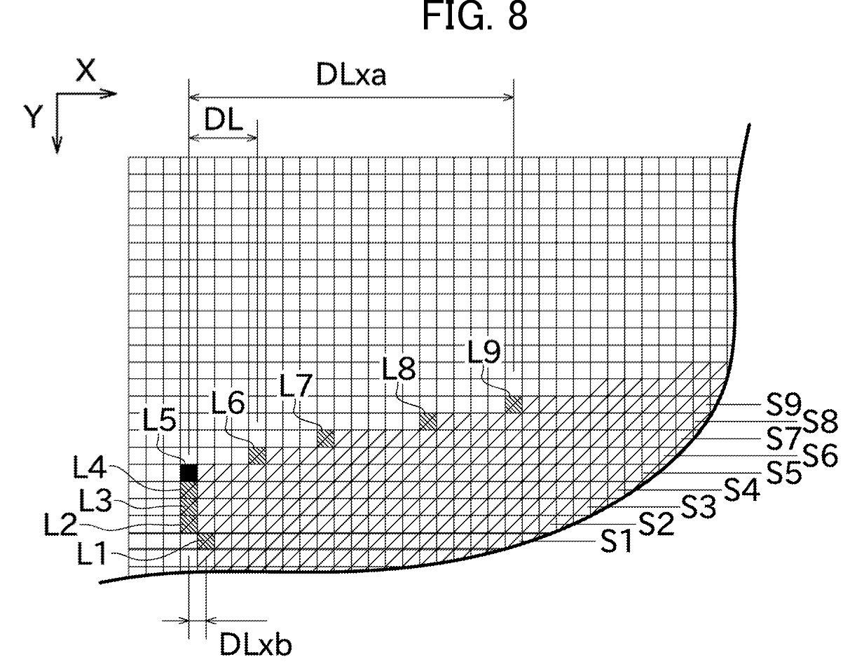

The determinations made in S301 an S302 will be described in detail with reference to FIG. 8. In FIG. 8, the currently processed line S1 is illustrated. It is assumed that the position of the left edge pixel L1 is acquired as illustrated in FIG. 8 in the process of S103 of FIG. 3. It is also assumed that the positions of the left edge pixels L2 through L9 are acquired and stored in the processes performed on the previously processed eight lines.

In this case, as described above, in the process of S301 of FIG. 7, in the area of the five lines from S9 to S5, as the past line comes closer line by line to the new line, it is checked whether each of the left edge pixels stays at the same position or moves towards the left.

In FIG. 8, for example, as the earliest processed line S9 shifts to the new line S8, the position of the left edge pixel moves from L9 to L8 in a direction that comes closer to the left edge. It is the same in the cases in which the line S8 shifts to the line S7, the line S6 shifts to the line S5 (L8 through L5). Accordingly, in the case of FIG. 8, it is determined that the conditions of S301 of FIG. 7 are met.

In the process of S302, in the area of the five lines from S5 to S1, as the previous line comes closer line by line to the new line, it is determined whether each of the left edge pixels stays at the same position or moves towards the right.

In the example of FIG. 8, when the line S5 shifts to the line S4, it is obvious from L5 and L4 that the left edge pixel stays at the same position. When the line S4 shifts to the line S3, and when the line S3 shifts to the line S2, each of the left edge pixels stays at the same position (L4 through L2). When the line S2 shifts to the currently processed line S1, the left edge pixel from L2 to L1 moves in a direction that comes closer to the right edge. Accordingly, in the case of FIG. 8, it is determined that the conditions of S302 of FIG. 7 are met.

Accordingly, in the example of FIG. 8, the sub routine proceeds to the process of S303, and the left-hand corner portion of the original document is recognized. More specifically, as illustrated in FIG. 8, the position of the left edge pixel L5 that is on the line S5 positioned at the approximate center of the nine lines is recognized as the position of the left-hand corner portion (refer to the blackened grid). The detected position of the left-hand corner portion of the original document is stored in the proper memory.

When the left-hand corner portion of the original document is detected, it is determined in the process of S304 of FIG. 7 whether or not the corner portion has a right angle.

The determination of the right angle is performed as follows. That is, a distance DLxa by which the left edge pixel moves from the earliest processed line S9 to the center line S5 towards the left edge side is acquired. A distance DLxb by which the left edge pixel moves from the center line S5 to the currently processed line S1 towards the right edge side is also acquired.

Then, when the “DLxa>DLxb”, it is checked whether or not a distance DL by which the left edge pixel moves towards the right edge side while the center line S5 shifts to the old line by DLxb lines substantially equals 4. When the distance DL substantially equals about 4, it is determined that the corner portion has a right angle. When the distance DL does not substantially equal about 4, it is determined that the corner portion does not have a right angle.

When the “DLxa<DLxb”, it is checked whether or not a distance DL by which the left edge pixel moves towards the right edge side while the center line S5 shifts to the new line by DLxa lines substantially equals about 4. When the distance DL substantially equals about 4, it is determined that the corner portion has a right angle, and when the distance DL does not substantially equal about 4, it is determined that the corner portion does not have approximately a right angle.

In the example of FIG. 8, while the earliest processed line S9 shifts to the center line S5, the left edge pixel moves by 19 pixels towards the left edge side (see the positions of L9 and L5). While the center line S5 shifts to the currently processed line S1, the left edge pixel moves by 1 pixel towards the right edge side (see the positions of L5 and L1). Accordingly, since the “DLxa=19”, and the “DLxb=1”, the “DLxa>DLxb. While the center line S5 shifts to the line S6, since the left edge pixel moves from L5 to L6 by 4 pixels towards the right edge side, the “DL=4”. Accordingly, in the example of FIG. 8, it is determined in the process of S304 of FIG. 7 that the left-hand corner portion is substantially perpendicular.

In the process of S305, the status regarding the direction of the original document is acquired. More specifically, when the distances DLxa and DLxb satisfy the relationship of “DLxa>DRxb”, the rotation in the counterclockwise direction is determined, and when the distances DLxa and DLxb satisfy the relationship of “DLxa<DRxb”, the rotation in the clockwise direction is determined.

In the example of FIG. 8, since the “DLxa>DLxb”, it is determined that the image is rotated in the counterclockwise direction. Accordingly, in the process of S305, the status of “counterclockwise rotation” is stored in the proper memory in association with the position of the left-hand corner portion acquired in the process of S303.

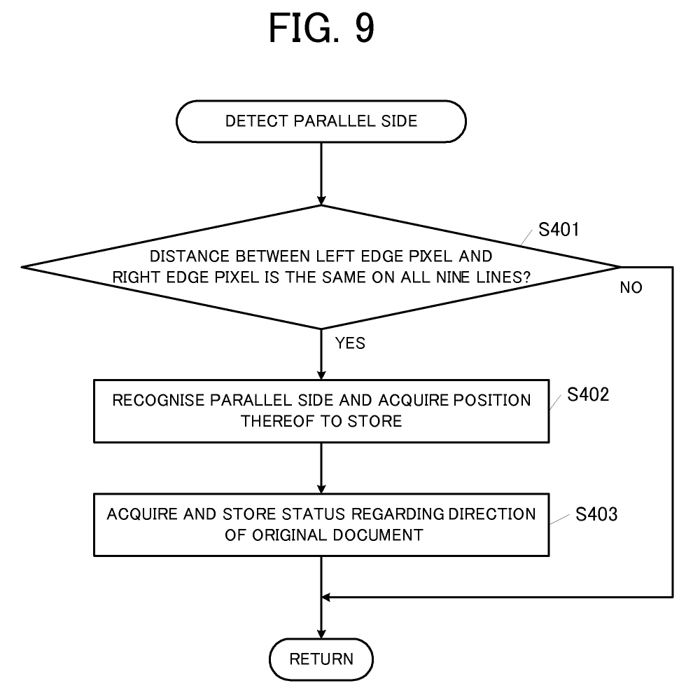

Next, with reference to FIG. 9, a process of detecting points on substantially parallel sides of the original document will be described as the third example of a specific process in which feature points are detected. Similar to the flowcharts of FIGS. 5 and 7, the flowchart of FIG. 9 represents one sub routine executed in the process of S104 of FIG. 3.

In the sub routine of FIG. 9, first, it is checked whether or not a distance between the left edge pixel and the right edge pixel in each of the nine lines is substantially the same (S401). When the conditions of S401 are met, the substantially parallel sides are recognized (S402). When the conditions are not met, it is determined that the substantially parallel sides have not been detected, and the sub routine is ended.

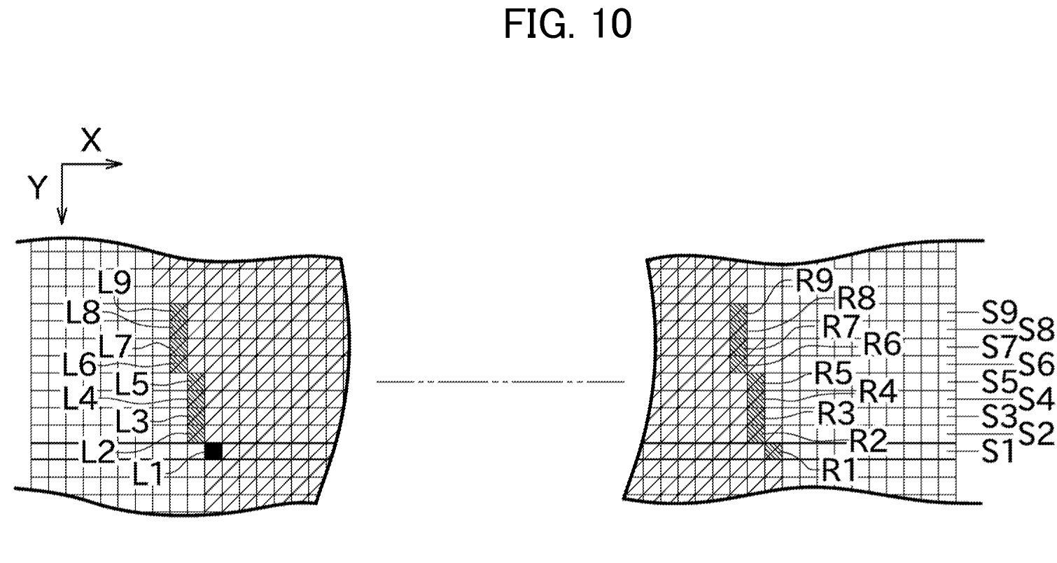

The determination made in S401 will be described in detail with reference to FIG. 10. In FIG. 10, the currently processed line S1 is illustrated. It is assumed that, as a result of the process of S103 of FIG. 3, the positions of the left edge pixel L1 and the right edge pixel R1 are acquired as illustrated in FIG. 10. It is also assumed that the positions of the left edge pixels L2 through L9 and of the right edge pixels R2 through R9 are acquired and stored in the processes performed on the immediately previously processed eight lines.

In this case, as described above, it is checked in the process of S401 whether or not the distance between the left edge pixel and the right edge pixel in each of the nine lines S1 through S9 is the same.

For example, in FIG. 10, it is obvious from the drawing that the distance between the left edge pixel and the right edge pixel in each of the nine lines S1 through S9 is substantially the same. Accordingly, in the case of FIG. 10, it is determined that the conditions of S401 of FIG. 9 are met.

Accordingly, in the case of FIG. 10, the sub routine proceeds to the process of S402, and the substantially parallel sides of the original document are recognized. In the process of S402, an arbitrary point on one of the substantially parallel sides is selected and a position thereof is stored in the proper memory. In the present preferred embodiment of the present invention, the position of the left edge L1 pixel on the currently processed line S1 is stored as a feature point (refer to the blackened grid). The position of the right edge pixel or the position of any edge pixel that is on the previously processed lines S2 through S9 may be stored as the feature point. It is preferable to set both positions of the left edge pixel and the right edge pixel as the feature points because a feature point count based on the substantially parallel sides is increased, thereby enhancing accuracy.

Next, in the process of S403 of FIG. 9, the status regarding the direction of the original document is acquired. More specifically, the position “L9” of the left edge pixel of the line S9, which was the earliest processed, is compared with the position “L1” of the left edge pixel of the currently processed line S1. When the position “L1” is closer to the left edge side than the position “L9”, the rotation in the clockwise direction is determined, and when the position “L9” is closer to the left edge side than the position “L1”, the rotation in the counterclockwise direction is determined. When the positions “L1” and “L9” are the same, it is determined that the document is not inclined.

In the example of FIG. 10, the position “L9” is closer to the left edge side than the position “L1”. Accordingly, in the process of S403, the status of “counterclockwise rotation” is stored in the proper memory in association with the position of the point on the substantially parallel side acquired in the process of S402. Then, the sub routine is ended.

When a substantially rectangular original document is scanned, a plurality of feature points is consecutively detected on a substantially parallel side. In order to prevent such a situation, once the substantially parallel side is detected, it is preferable that a prescribed number of lines will not be detected. The prescribed number of lines is determined in accordance with the resolution and accuracy of a detection angle, or other suitable parameter. For example, when the scan resolution is 200 dpi, and the number of lines by which the detection of the substantially parallel side is skipped is set to be about 200, the feature points on the parallel side are detected at an interval of at least about 25.4 mm, for example.

By executing the above-described three sub routines, the leading corner portion, the left-hand corner portion, and the parallel sides can be detected. In addition to the above, in the process of S104 of the main routine, sub routines are preferably executed to detect a corner portion (a trailing corner portion) positioned on a trailing side of the original document and a corner portion (a right-hand corner portion) positioned on the right side. Description of the sub routine for detecting the right-hand corner portion will be omitted since the routine can be performed by reversing a positional relationship in the main scanning direction in the above-described sub routine for detecting the left-hand corner portion.

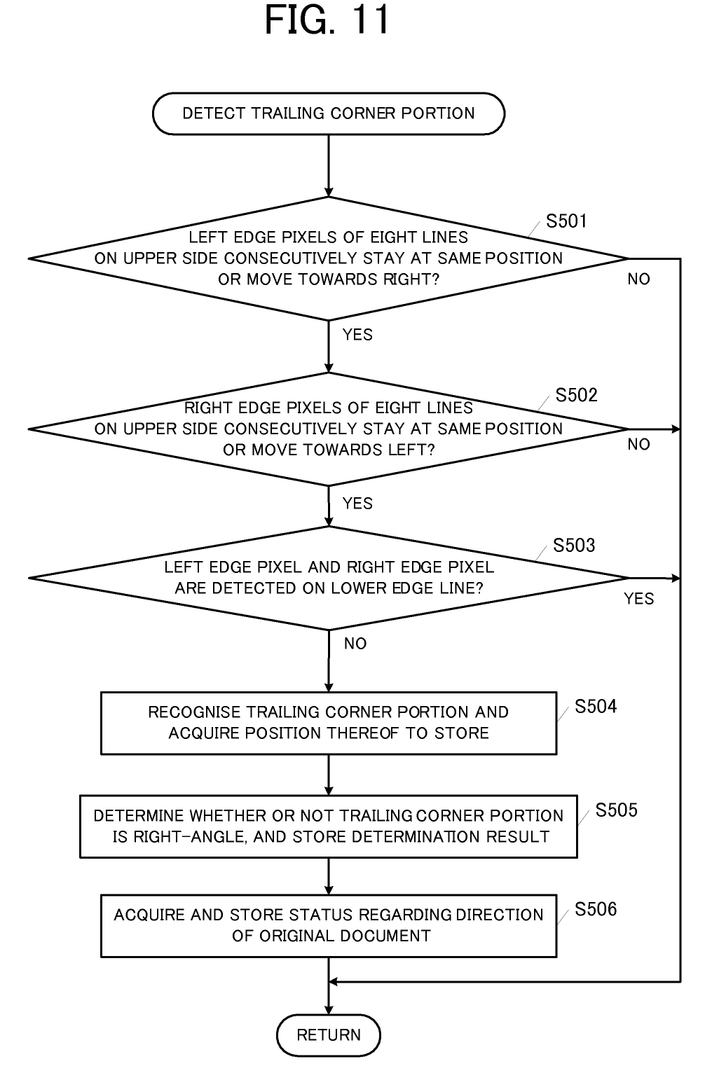

The sub routine to detect the trailing corner portion will be described with reference to FIG. 11. In the sub routine of FIG. 11, first, in the eight lines from the line that was processed earliest to the line that is immediately before the current line, as the past line comes closer line by line to the new line, it is checked whether each of the left edge pixels consecutively stays at the same position or moves towards the right (S501). When these conditions are not met, it is determined that the trailing corner portion has not been detected, and the sub routine is ended.

When the conditions of S501 are met, as the earliest processed line comes closer line by line to the line immediately before the current line, it is checked whether each of the right edge pixels consecutively stays at the same position or moves towards the left (S502). When these conditions are not me, it is determined that the trailing corner portion has not been detected, and the sub routine is ended.

When the conditions of S502 are met, in the currently processed line, it is checked whether or not the left edge pixel and the right edge pixel are detected (S503). When the pixels are not detected, the trailing corner portion is recognized, and the position thereof is acquired and stored (S504). When the pixels are detected, it is determined that the trailing corner portion has not been detected, and the sub routine is ended.

As the line comes closer to the trailing corner portion of the original document, the left edge pixel moves towards the right side, and the right edge pixel moves towards the left side. When the line passes through the trailing corner portion, the original document pixel is not detected. The processes of S501 through S504 automatically determine the trailing corner portion by using the features of the trailing corner portion.

Next, it is determined whether or not the detected trailing corner portion is approximately a right angle, and a determination result is stored (S505). The status regarding the direction of the original document is acquired and stored (S506). Since the processes of S505 and S506 are essentially similar to the detection process of the leading corner portion (FIG. 5), the right angle determining process (S204), and the direction determining process (S205), description thereof will be omitted.

When each of the above-described sub routines is ended, and the process of S104 of FIG. 3 is completed, it is determined whether or not the pixel data of all lines has been input (S105). When the input of all lines has not been completed, the process returns to the process of S101.

Each time one line is input, the processes of S103 and S104 are repeated until the original document scanned data of all lines are input by the above-described flow. Accordingly, by looping the processes of S101 through S104, the feature points indicating the leading corner portion, the left-hand corner portion, the trailing corner portion, the right-hand corner portion, and the substantially parallel side of the original document are detected. Each time the feature point is detected, the position thereof, the determination result indicating whether or not the corner portion has a right angle, and the status regarding the direction of the original document are stored.

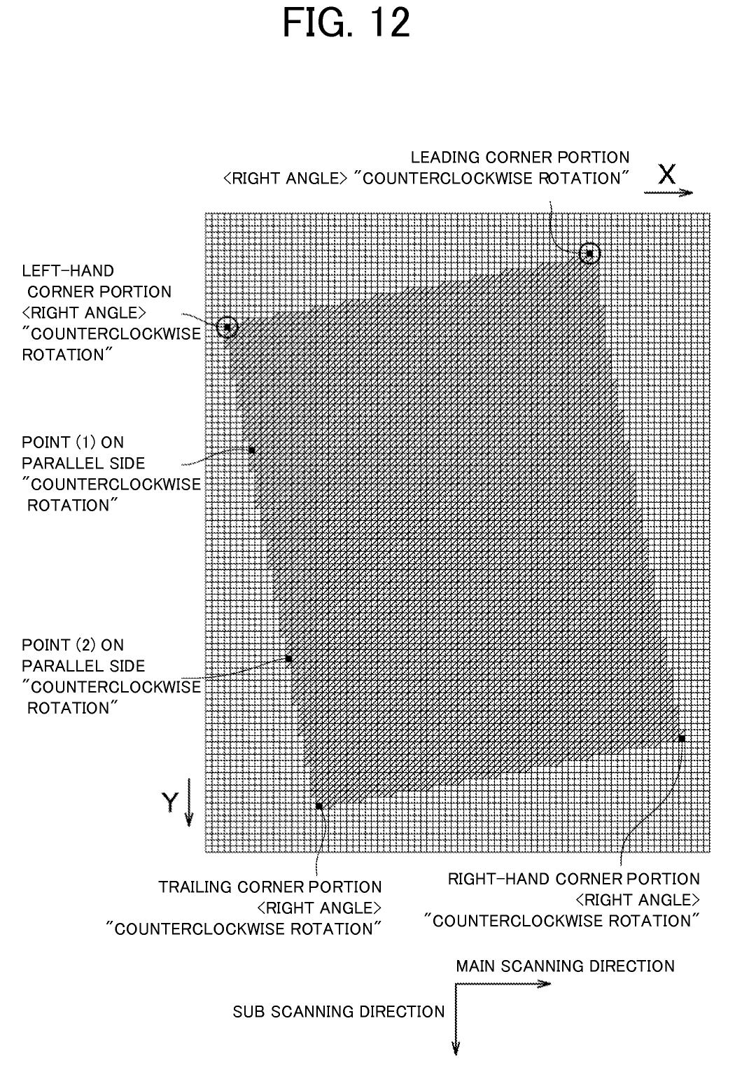

FIG. 12 illustrates an example of the positions of the detected feature points, and the determination of right angle and the status acquired with respect to each feature point. With respect to the substantially parallel side, two mutually and sufficiently separated points (point (1) and (2) on the substantially parallel side) are recognized, and each of the positions and statuses thereof is stored.

When the process performed for the data of all lines is completed, the main routine preferably proceeds to the process of S106 of FIG. 3. In the process of S106, the feature point of the corner portion that has been determined as non right-angle is excluded from the feature points detected in S104. The excluded feature point is not used in the processes of S107 and S108 to be described below. In the example of FIG. 12, since it is determined that each of the four corner portions has an approximate right angle, no feature point is excluded.

Next, the statuses of the acquired feature points are counted, and the most commonly counted status is determined (S107). In the example of FIG. 12, since the statuses of all feature points indicate the “counterclockwise rotation”, the most commonly counted status is determined as the “counterclockwise rotation”. A plurality of most commonly counted statuses may be determined. In such a case, the status is determined in accordance with a predetermined priority order.

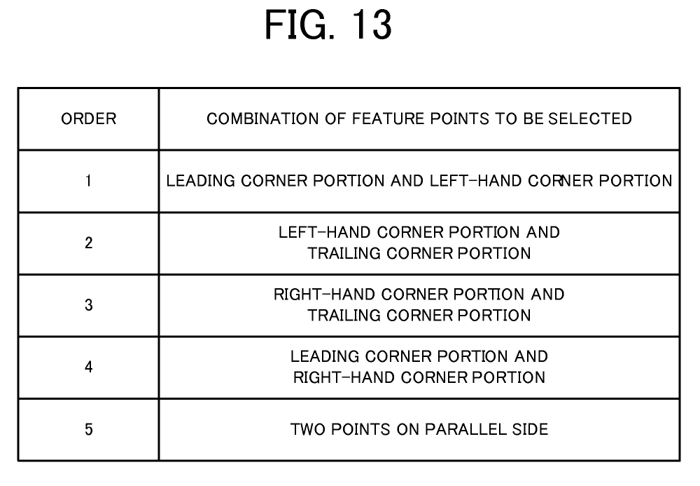

Next, in the process of S108 of FIG. 3, in accordance with the predetermined priority order, a combination of two feature points is selected from the feature points having the status that matches the most commonly counted status. An example of the priority order is represented in FIG. 13. In the example, the priority order is set such that the two points of the separate corner portions of the original document are preferably higher on the priority order than the two points on the parallel side. Thus, the detection accuracy of the inclination can be improved.

In the example of FIG. 12, since the statuses of all feature points are the “counterclockwise rotation”, any feature point can be selected. However, in accordance with the priority order of FIG. 13, the leading corner portion and the left-hand corner portion are preferably selected.

Next, the process proceeds to the process of S109 of FIG. 3, and based on the positions of the selected two feature points, a value regarding the inclination of the original document is calculated. In the present preferred embodiment of the present invention, based on the positions of the points of the selected leading corner portion and the left-hand corner portion, a tangent value of an inclination angle of the original document is preferably acquired. However, a value of the inclination angle of the original document may be acquired based on the inclination of a straight line linking the two feature points, or a sine value or a cosine value may be calculated, for example. That is, any parameter that represents a degree of the inclination may be used.

In the calculating process of S107, the statuses of the feature points may be dispersed, and the most commonly counted status may not be acquired. In such a case, regardless of the status, the inclination of the original document is acquired based on the two points of the substantially parallel side if the two points on the parallel side have been acquired.

By the above-described process, similar to the scanned data of the CCD 28, based on the data consecutively output pixel by pixel with respect to each line, the parameter regarding the inclination of the original document can be calculated and acquired. Then, by sending the parameter (i.e., the tangent value) to the inclination correcting unit 68, an image rotating process of an appropriate angle can be performed, and a preferable scanned image in which the inclination is electronically corrected can be acquired.

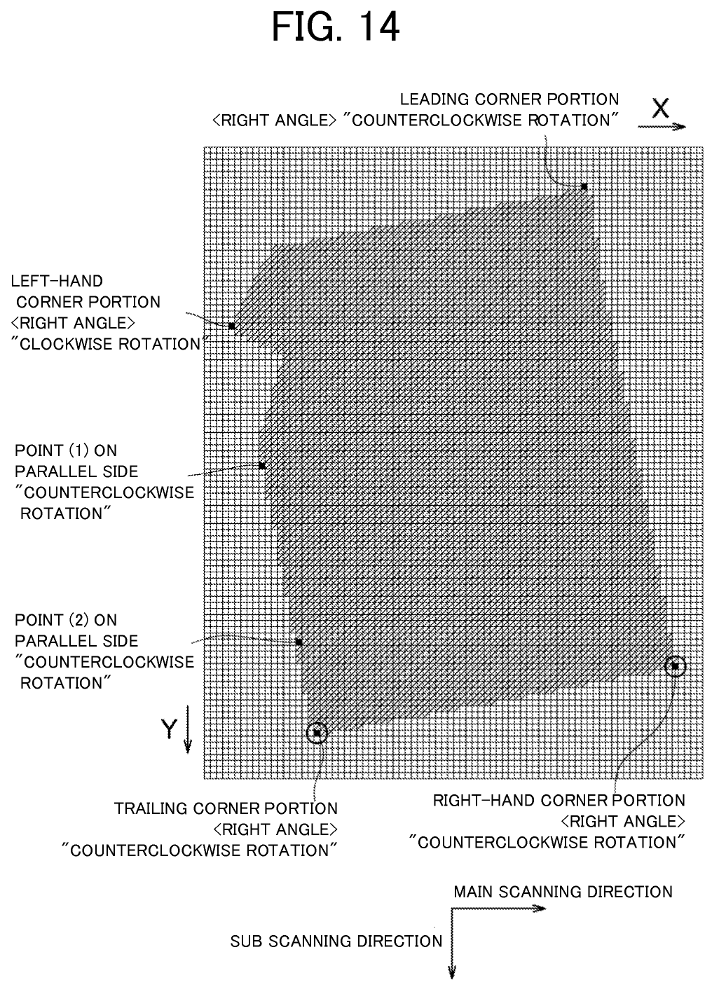

In the above-described inclination detecting process, even if the original document is dog-eared, torn, or otherwise damaged, the inclination can be preferably detected. For example, an example of a scanned result is illustrated in FIG. 14 in which the left-hand corner portion of the original document is dog-eared and torn. In the example of FIG. 14, it is assumed that, when the left-hand corner portion is detected as the feature point, based on features of a shape of the dog-eared portion, it is determined that the left-hand corner portion has an approximate right angle and that the status is the “clockwise rotation”. Similar to FIG. 12, it is assumed that the feature points of the portions other than the left-hand corner portion are determined to have a right angle if the portions are a corner portion, and that the status of “counterclockwise rotation” is acquired.

In FIG. 14, one feature point indicates the status of “clockwise rotation”, and other five feature points indicate the status of “counterclockwise rotation”. Accordingly, in the process of S107 of FIG. 3, the most counted status is determined to be the “counterclockwise rotation”. As a result, when the feature points of S108 are selected, since a left-hand corner portion of FIG. 14 has the status of “clockwise rotation”, which does not match the most commonly counted status, the left-hand corner portion is not selected. Therefore, in accordance with the priority order of FIG. 13, a right-hand corner portion and a trailing corner portion are selected, and based on the two feature points thereof, the inclination of the original document is accurately detected.

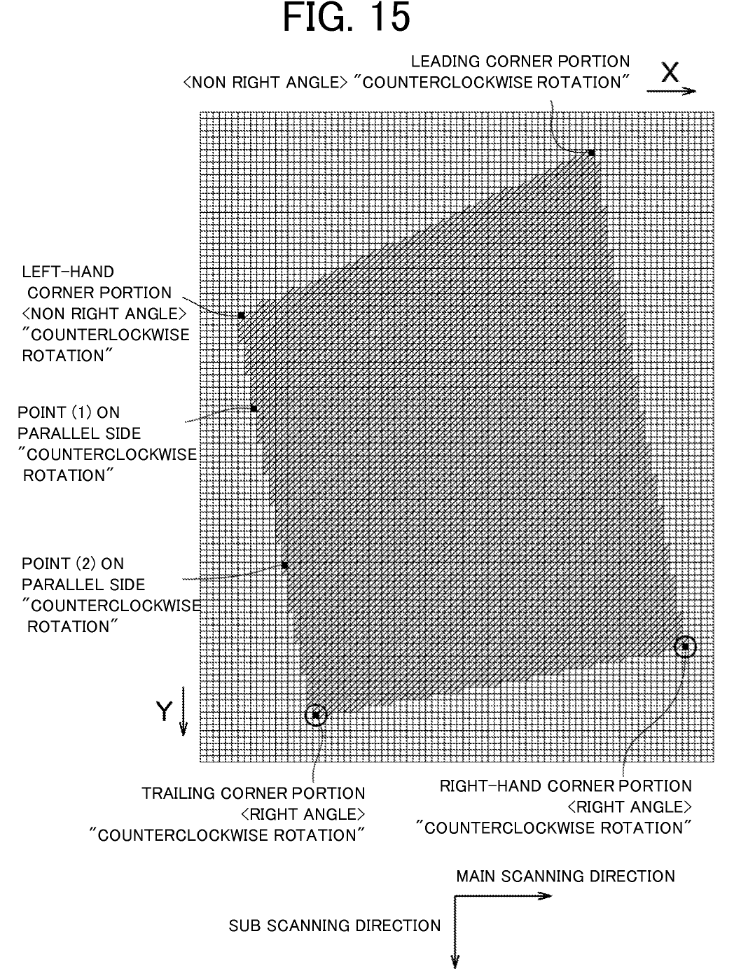

FIG. 15 illustrates an example of a scanned result in which the original document is substantially dog-eared at its leading side and thus has a non-rectangular shape. In the example of FIG. 15, when a leading corner portion and a left-corner portion are detected as the feature points, it is determined that the portions do not have an approximate right angle, and it is determined that a trailing corner portion and a right-corner portion has an approximate right angle.

In this case, in the process of S106 of FIG. 3, the leading corner portion and the left-hand corner portion that are not approximate right angles are excluded. Accordingly, in the determining process of the most commonly counted status of S107 and the feature point selecting process of S108, the leading corner portion and the left-hand corner portion are excluded. In the example of FIG. 15, the right-hand corner portion and the trailing corner portion are selected, and based on the two feature points thereof, the inclination of the original document is accurately detected.

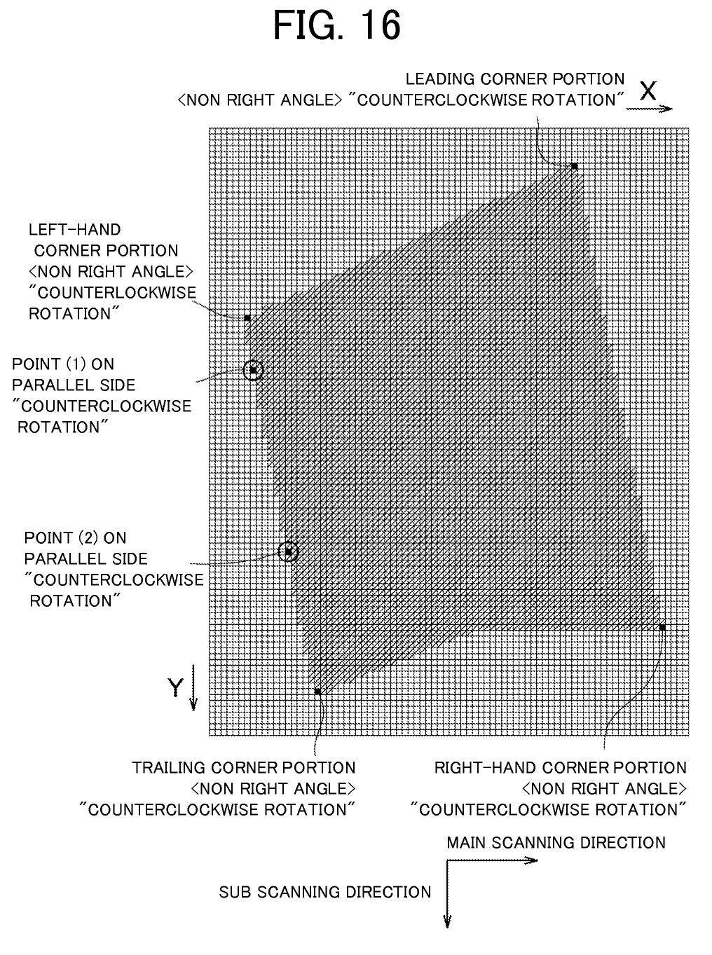

FIG. 16 illustrates an example of a case in which a non-square original document is scanned. It is determined that all of the four detected corner portions do not have an approximate right angle. In such a case, since all of the four corner portions are excluded in the process of S106 of FIG. 3, two points on a substantially parallel side are selected in the process of S108. Accordingly, even if the original document has a non-square shape, as long as the document has a substantially parallel side, the inclination can be accurately detected based on two points on the substantially parallel side.

The inclination detecting process of the above-described present preferred embodiment of the present invention detects and analyzes the original document pixels, and thus, can properly detect the inclination of the original document regardless of the content of the original document. Moreover, the inclination of original documents of various shapes or in various states can be accurately detected even when the original document is dog-eared, torn, for example, or has a round-cornered rectangular shape, a non-rectangular shape, a non-square shape, or other unconventional shape.

As described above, the inclination detecting unit 67 of the image scanner apparatus of the present preferred embodiment of the present invention includes, for example, the edge pixel acquiring unit 71, the feature point detecting unit 72, the status acquiring unit 73, and the inclination calculating unit 74. The edge pixel acquiring unit 71 inputs image data line by line, and detects, with respect to each line, a left edge pixel and a right edge pixel that are positioned at the boundary between the original document and the background. Based on the position of at least one of the left edge pixel and the right edge pixel of the nine lines, the feature point detecting unit 72 preferably detects the positions (positions of each point on the corner portion and on the substantially parallel side) of the feature points of the original document. Based on the position of at least one of the left edge pixel and the right edge pixel of the nine lines that includes the position of the feature point, with respect to each of the feature points, the status acquiring unit 73 acquires the status regarding the inclination of the original document. The inclination calculating unit 74 preferably counts the statuses of a plurality of feature points, acquires the most commonly counted status, selects two feature points from the feature points having the status that matches the most counted status, and calculates, from the positions of the two feature points, a tangent value that represents the inclination of the original document, for example.

Thus, the inclination detection performed by a comprehensive determination using the feature points and the statuses thereof of the original document can be achieved. Therefore, the accuracy of the inclination detection can be improved. Moreover, the inclination of original documents having various shapes can be properly detected.

In accordance with the predetermined priority order, the inclination detecting unit 67 preferably selects two feature points from the feature points having the status that matches the most commonly counted status.

Thus, by properly predetermining the priority order, the accuracy of the inclination detection can be further improved. Moreover, since the process of selecting the feature points can be simplified, the time required for the process of the inclination detection can be reduced. Furthermore, the scanned original document may not have a substantially rectangular shape. However, by changing the priority order, a user can set from which portion of the original document the feature point is detected in priority. Accordingly, various requirements in which the leading side of the original document is prioritized, the left side of the original document is prioritized, or other portions of the original document are prioritized, can be met.

The feature point detecting unit 72 can detect the corner portion of the original document as the feature point, for example.

Thus, by using the corner portion of the original document as the feature point, the two sufficiently separated feature points, such as the leading corner portion and the left-hand corner portion, can be selected for the inclination calculation, for example. Accordingly, the inclination of the original document (i.e., a tangent value) can be accurately detected.

When the corner portion of the original document is detected as the feature point, based on the feature of the position of at least one of the left edge pixel and the right edge pixel, the feature point detecting unit 72 preferably determines whether or not an angle of the corner portion is an approximate right angle. When the angle of the corner portion is not an approximate right angle, the inclination calculating unit 74 excludes the feature point thereof and then counts the statuses. Then, after excluding the corner portion from the feature points having the status that matches the most commonly counted status, the inclination calculating unit 74 preferably selects the two feature points to calculate the inclination.

Thus, when the original document has the shapes illustrated in FIGS. 15 and 16, for example, the calculation of the inclination based on the corner portion that does not have an approximate right angle can be prevented, thereby preventing erroneous detection of the inclination.

As illustrated by the points (1) and (2) on the substantially parallel side of FIG. 16, for example, the feature point detecting unit 72 can acquire, as the feature points, the two points positioned on one of the substantially parallel sides (i.e., on a left side) that oppose each other on the right side and the left side (on both sides of a line) of the original document, with the two points being positioned at a portion other than the corner portion of the original document.

Thus, even when an original document having an irregular shape (such as an original document having a non-rectangular shape or a non-square shape, for example) is scanned, as long as the document has a substantially parallel side, the inclination of the original document can be properly detected based on the two feature points positioned on the substantially parallel side.

When the most commonly counted status cannot be acquired, the inclination calculating unit 74 calculates the inclination (i.e., a tangent value) of the original document based on the positions of the two feature points positioned on one of the substantially parallel sides of the original document.

Thus, even if the original document has a round-cornered shape, for example, and it is difficult to detect the accurate position of the corner portion, as long as the document has a substantially parallel side, the inclination of the original document can be properly detected based on the substantially parallel side. Accordingly, the inclination detection with high versatility can be performed.

As illustrated in FIG. 2, the image scanner apparatus 101 of the present preferred embodiment of the present invention includes the image scanning unit 115 arranged to acquire image data by scanning an original document and the inclination correcting unit 68. Based on the inclination (i.e., a tangent value) acquired by the inclination detecting unit 67 processing the image data acquired by the image scanning unit 115, the inclination correcting unit 68 preferably performs the rotation process of the image data so as to correct the inclination.

Thus, by accurately detecting the inclination of the original document in accordance with the comprehensive determination, the inclination correction can be performed. Moreover, the inclination correction can be properly performed on an original document having various shapes.

In the image scanner apparatus 101, the edge pixel acquiring unit 71 of the inclination detecting unit 67 preferably acquires the positions of the left edge pixel and the right edge pixel of each line that is arranged along the main scanning direction of the image scanning unit 115.

Thus, by matching the main scanning direction and a direction of the lines, while the pixel data consecutively input in the main scanning direction at the time of image scanning is sequentially processed, the positions of the left edge pixel and the right edge pixel can be acquired. Accordingly, since a process of accumulating the image data in the memory and then reading out the pixel data in the line direction can be omitted, the processes can be simplified, and the detection of the inclination of the scanned image can be performed at high speed.

In the present preferred embodiment of the present invention, as illustrated in FIG. 1, the image scanning unit 115 preferably includes the flat bed unit.

Accordingly, even when the original document is placed on the flat bed unit in an inclined state, an image that is corrected in a proper direction can be acquired by the inclination correcting unit 68. Therefore, the original document can be placed in any direction or orientation on the platen glass 102 of the flat bet unit and scanned, thereby facilitating operational performance.

The preferred embodiments of the present invention have been described above, however, the above-described configuration may be modified as follows.

In the process of S102 of FIG. 3, by using the difference of luminance between the white color of the pressing pad 121 and the pressing member 122 and the white color of the original document, the original document pixel and the background pixel are detected. However, other methods can be used to detect the original document pixel and the background pixel. For example, a yellow platen glass sheet may be attached to the pressing pad 121 and the pressing member 122. In such a case, a Cb value, which is a parameter regarding colors, is calculated from input RGB value by using a well-known expression, and by comparing the Cb value with a prescribed threshold value, the original document pixel and the background value can be detected.

Alternatively, an original document may be placed on the platen glass 102 of the flat bed unit and scanned in a state in which the original document table cover 104 is open. In such a case, the reflection light is not detected in an area on which the original document is not disposed, and the area is detected as black pixels. Thus, the pixels detected as black on both sides of a line can be recognized as background pixels. More specifically, a sensor to detect the opening and closing of the original document table cover 104 may be provided to the image scanner apparatus 101, and the above-described process may be performed when the sensor detects that the original document table cover 104 is open, for example.

In the process of S103 of FIG. 3, after binarized pixels of one line are stored in the memory, original document pixels may be searched from one edge to the other edge (and from the other edge to the one edge) of the line, and a position of the first appearing original document pixel may be recognized as an edge pixel. However, it is preferable to check a change of pixels one pixel at a time from the left edge to the right edge as described in the above-described preferred embodiments of the present invention and to recognize two edge pixels in that the above-described preferred embodiments of the present invention do not require a memory and can process data sequentially.

The feature point detecting process of S104 preferably detects the feature points based on the positions of the left edge pixels and the right edge pixels of the nine lines. However, in view of accuracy required to detect angles, scan resolution, a memory capacity, and processing load, for example, the number of lines used to detect the feature points from the positions of the left edge pixels and the right edge pixels may be appropriately modified.

The process of S104 may be modified such that, in addition to the four corner portions and the parallel side, the right edge pixel on a line of the left-hand corner portion and the left edge pixel on a line of the right-hand corner portion are detected as the feature points. The process of S104 may also be modified such that three or more points are detected on the parallel side.

In addition to the “no inclination” status, the “clockwise rotation” status, and the “counterclockwise rotation” status, a status of “rotation by 45 degrees” of the feature point, for example, may be detected and stored.

Alternatively, it may be modified such that the inclination is detected only when the most commonly counted status acquired by counting a plurality of statuses of the feature points exceeds the status of a clear majority of feature points, and the inclination detection is discontinued when the most commonly counted status does not exceed the clear majority. Moreover, instead of the clear majority, it may be modified such that the inclination is detected only when the most commonly counted status exceeds approximately two-thirds, for example.

The priority order illustrated in FIG. 13 may be modified in accordance with the usage and purpose of the image scanner apparatus 101. For example, when a plurality of non-rectangular original documents is expected to be scanned, it may be modified such that two points on a parallel side are selected in priority.

If possible, it may be modified such that by withdrawing from the loop of S101 through S104 of FIG. 3, a processing period of time is reduced. For example, in the case of FIG. 12, when the image is input and processed line by line from an upper edge thereof, the feature point of the leading corner portion, then the left-hand corner portion, the point (1) on the substantially parallel side, the point (2) on the substantially parallel side are sequentially detected. It is assumed that at the time when the point (2) on the substantially parallel side is detected, all of the statuses of the four feature points that have been detected are the “counterclockwise rotation”. In such a case, it is assured that, regardless of the statuses of the right-hand corner portion and the trailing corner portion to be detected later, the most commonly counted status will be the “counterclockwise rotation”. Accordingly, at the time when the four feature points before the point (2) on the substantially parallel side are detected, the loop process of S101 through S104 of FIG. 3 may be stopped, the process may proceed to the processes after that of S105, the leading corner portion and the left-hand corner portion may be selected in accordance with the priority order of FIG. 13, and the inclination may be calculated. Thus, the processing period of time for inclination detection can be preferably reduced, achieving high-speed scanning.

The above-described inclination detecting process according to preferred embodiments of the present invention may be applied not only to a color image but also to a monochrome image.

The above-described inclination detecting process according to preferred embodiments of the present invention may be applied not only to the image scanner apparatus 101 but also to other image scanning apparatuses such as a copier, a facsimile machine, a Multi Functional Peripheral, an Optical Character Reader (OCR), for example.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
an edge pixel acquiring unit arranged to acquire, with respect to each line of image data acquired by having an original document scanned, positions of a first edge pixel and a second edge pixel that are positioned at a boundary between the original document and a background;
a feature point detecting unit arranged to detect a feature point of an outline of the original document based on a feature of the position of at least one of the first edge pixel and the second edge pixel of a plurality of lines of the image data;
a status acquiring unit arranged to acquire, with respect to each feature point, a status indicating that the original document is one of not inclined, inclined towards one side, or inclined towards the other side, based on the feature of the position of at least one of the first edge pixel and the second edge pixel, of the line that includes a position of the relevant feature point, or of the line that is in the vicinity of the line that includes a position of the relevant feature point; and
an inclination calculating unit arranged to count the statuses of a plurality of feature points, determine the most commonly counted status, select two feature points from the feature points that have the status that matches the most commonly counted status, and calculate a value regarding an inclination of the original document from the positions of the two feature points.

2. The image processing apparatus according to claim 1, wherein the inclination calculating unit selects, in accordance with a predetermined priority order, the two feature points from the feature points that have the status that matches the most commonly counted status.

3. The image processing apparatus according to claim 1, wherein the feature point detecting unit is arranged to detect a corner portion of the original document as the feature point.

4. The image processing apparatus according to claim 3, wherein
when the corner portion of the original document is detected as the feature point, the feature point detecting unit determines whether or not the corner portion has an approximate right angle based on the feature of the position of at least one of the first edge pixel and the second edge pixel; and
when the corner portion does not have an approximate right angle, the inclination calculating unit excludes the relevant feature point, then counts the statuses, and selects the two feature points after excluding the corner portion from the feature points that have the status that matches the most commonly counted status.

5. The image processing apparatus according to claim 3, wherein the feature point detecting unit is arranged to acquire, as the feature points, at least two points that are positioned on one of a plurality of substantially parallel sides of the original document opposing each other on each side of the original document in a longitudinal direction thereof and that are not positioned on the corner portion of the original document.

6. The image processing apparatus according to claim 5, wherein when the most commonly counted status cannot be determined, the inclination calculating unit calculates the value regarding the inclination of the original document from the two feature points that are positioned on the substantially parallel side of the original document.

7. An image scanning apparatus comprising:
an image scanning unit arranged to acquire image data by scanning an original document;
an edge pixel acquiring unit arranged to acquire, with respect to each line of the image data, positions of a first edge pixel and a second edge pixel that are positioned at a boundary between the original document and a background;
a feature point detecting unit arranged to detect a feature point of an outline of the original document based on a feature of the position of at least one of the first edge pixel and the second edge pixel of a plurality of lines;
a status acquiring unit arranged to acquire, with respect to each feature point, a status indicating that the original document is one of not inclined, inclined towards one side, or inclined towards the other side, based on the feature of the position of at least one of the first edge pixel and the second edge pixel of the line that includes a position of the relevant feature point or of the line that is in the vicinity of the former line;
an inclination calculating unit arranged to count the statuses of a plurality of feature points, determine the most commonly counted status, select two feature points from the feature points that have the status that matches the most commonly counted status, and calculate a value regarding inclination of the original document from the positions of the two feature points; and
a rotation processing unit arranged to perform a rotation process on the image data so as to correct the inclination thereof based on the value regarding the inclination.

8. The image scanning apparatus according to claim 7, wherein the edge pixel acquiring unit is arranged to acquire the positions of the first edge pixel and the second edge pixel of each line that is arranged along a main scanning direction of the image scanning unit.

9. The image scanning apparatus according to claim 7, wherein the image scanning unit includes a flat bed unit.

10. The image scanning apparatus according to claim 7, wherein the inclination calculating unit selects, in accordance with a predetermined priority order, two feature points from the feature points that have the status that matches the most commonly counted status.

11. The image scanning apparatus according to claim 7, wherein the feature point detecting unit is arranged to detect a corner portion of the original document as the feature point.

12. The image scanning apparatus according to claim 11, wherein
when the corner portion of the original document is detected as the feature point, the feature point detecting unit determines whether or not the corner portion has an approximate right angle based on the feature of the position of at least one of the first edge pixel and the second edge pixel; and
when the corner portion does not have an approximate right angle, the inclination calculating unit excludes the feature point corresponding to the corner portion, then counts the statuses, and selects the two feature points from the feature points that have the status that matches the most commonly counted status after excluding the feature point of the corner portion.

13. The image scanning apparatus according to claim 11, wherein the feature point detecting unit is arranged to acquire, as the feature points, at least two points that are positioned on one of a plurality of substantially parallel sides of the original document facing each other on each side of the original document in a longitudinal direction thereof and are not positioned on the corner portion of the original document.

14. The image scanning apparatus according to claim 13, wherein when a number of the most commonly counted status cannot be acquired, the inclination calculating unit calculates a value regarding the inclination of the original document from the positions of the two feature points positioned on the substantially parallel side of the original document.

15. An image processing method comprising:
an edge pixel acquiring step of acquiring, with respect to each line of image data acquired by having an original document scanned, positions of a first edge pixel and a second edge pixel that are positioned at a boundary between the original document and a background;
a feature point detecting step of detecting a feature point of an outline of the original document based on a feature of the position of at least one of the first edge pixel and the second edge pixel of a plurality of lines;
a status acquiring step of acquiring, with respect to each feature point, a status indicating that the original document is one of not inclined, inclined towards one side, or inclined towards the other side, based on the feature of the position of at least one of the first edge pixel and the second edge pixel of the line that includes a position of the relevant feature point or of the line that is in the vicinity of the line that includes a position of the relevant feature point; and
an inclination calculating step of counting the statuses of a plurality of feature points, determining the most commonly counted status, selecting two feature points from the feature points that have the status that matches the most commonly counted status, and calculating a value regarding an inclination of the original document from the positions of the two feature points.

16. The image processing method according to claim 15, wherein the inclination calculating step selects, in accordance with a predetermined priority order, two feature points from the feature points that have the status that matches the most commonly counted status.

17. The image processing method according to claim 15, wherein the feature point detecting step detects a corner portion of the original document as the feature point.

18. The image processing method according to claim 17, wherein
when the corner portion of the original document is detected as the feature point, the feature point detecting step determines whether or not the corner portion has an approximate right angle based on the feature of the position of at least one of the first edge pixel and the second edge pixel; and
when the corner portion does not have an approximate right angle, the inclination calculating step excludes the relevant feature point, counts the statuses, and then selects the two feature points that match the most commonly counted status after excluding the corner portion from the feature points that have the status.

19. The image processing method according to claim 17, wherein the feature point detecting step acquires, as the feature points, at least two points that are positioned on one of a plurality of substantially parallel sides of the original document facing each other on each side of the original document in a longitudinal direction thereof and are not positioned on the corner portion of the original document.

20. The image processing method according to claim 19, wherein when the most counted status cannot be acquired, the inclination calculating step calculates the value regarding the inclination of the original document from the positions of the two feature points that are positioned on the substantially parallel side of the original document.
